(19) United States
(12) Patent Application Publication
(10) Pub. No.: US 2025/0117268 A1
(43) Pub. Date: Apr. 10, 2025

(54) SYSTEM AND METHOD FOR MULTI-PLATFORM INTEROPERABILITY IN DIGITAL ENVIRONMENTS

(71) Applicant: BANK OF AMERICA CORPORATION, Charlotte, NC (US)

(72) Inventors: Suryanarayan Parthasarathi Chakravarthi, Chennai (IN); Saisrikanth Chitty, Hyderabad (IN)

(73) Assignee: BANK OF AMERICA CORPORATION, Charlotte, NC (US)

(21) Appl. No.: 18/378,473

(22) Filed: Oct. 10, 2023

(51) Int. Cl. G06F 9/54

(52) U.S. Cl. CPC G06F 9/541

(57) ABSTRACT

Systems, computer program products, and methods are described herein for multi-platform interoperability in digital environments. The present disclosure is configured to receive one or more platforms, wherein the one or more platforms comprise multi-platform virtual reality, augmented reality, and extended reality environments. In some embodiments, receiving includes transferring the platform to a platforms operational layer. In some embodiments, the system may receive a central features repository dashboard, wherein the central features repository dashboard comprises one or more features. In some embodiments, the system may create a generate, integrate, and tailor (GINT) module, wherein the GINT module comprises a feature tailor, a feature integrator, and a feature generator; and aggregate, within the platforms operational layer, the one or more platforms, the central features repository dashboard, and the GINT module.

### TECHNOLOGICAL FIELD

Example embodiments of the present disclosure relate to multi-platform interoperability in digital environments.

### BACKGROUND

There are significant challenges associated with digital environments using different standards, technologies, and programming languages. Applicant has identified a number of deficiencies and problems associated with multi-platform interoperability in digital environments. Through applied effort, ingenuity, and innovation, many of these identified problems have been solved by developing solutions that are included in embodiments of the present disclosure, many examples of which are described in detail herein.

### BRIEF SUMMARY

The following presents a simplified summary of one or more embodiments of the present disclosure, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Systems, methods, and computer program products are provided for multi-platform interoperability in digital environments.

Embodiments of the present invention address the above needs and/or achieve other advantages by providing apparatuses (e.g., a system, computer program product, and/or other devices) and methods for multi-platform interoperability in digital environments. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives one or more platforms, wherein the one or more platforms comprise multi-platform virtual reality, augmented reality, and extended reality environments, and wherein receiving comprises transferring the platform to a platforms operational layer. In some embodiments, the present invention receives a central features repository dashboard, wherein the central features repository dashboard comprises one or more features. In some embodiments, the present invention creates a generate, integrate, and tailor (GINT) module, wherein the GINT module comprises a feature tailor, a feature integrator, and a feature generator. In some embodiments, the present invention aggregates, within the platforms operational layer, the one or more platforms, the central features repository dashboard, and the GINT module.

In some embodiments, the central features repository dashboard comprises receiving, from a user device, a user feature, wherein the user feature comprises features specific to a user. In some embodiments, the central features repository dashboard comprises receiving, from an entity device, an entity feature, wherein the entity features comprises features specific to an entity. In some embodiments, the central features repository dashboard comprises transmitting the user feature and the entity feature to the platforms operational layer in response to the GINT module.

In some embodiments, the GINT module comprises the feature tailor, wherein the feature tailor assigns properties to the features in the platforms operational layer based on the central features repository dashboard. In some embodiments, the GINT module comprises the feature integrator, wherein the feature integrator maps functions to the features in the platforms operational layer based on the central features repository dashboard. In some embodiments, the GINT module comprises the feature generator, wherein the feature generator generates functions in the features in the platforms operational layer based on the central features repository dashboard.

In some embodiments, the feature tailor comprises iterating an object property associated with the feature. In some embodiments, the feature tailor comprises assigning a parameter based on the central features repository dashboard. In some embodiments, the feature tailor comprises performing an object level interoperability.

In some embodiments, the feature integrator comprises mapping a platform request based on the central feature repository dashboard. In some embodiments, the feature integrator comprises mapping an object request based on the central feature repository dashboard. In some embodiments, the feature integrator comprises performing a feature level interoperability.

In some embodiments, the feature generator comprises generating, in response to the central features repository dashboard, a native platform characteristic, wherein the native platform characteristic comprises the one or more platform plugins, libraries, and packages. In some embodiments, the feature generator comprises performing a platform level interoperability.

In some embodiments, the present invention receives the feature from the central feature repository dashboard. In some embodiments, the present invention assigns, using the GINT module, properties to the feature in a first platform. In some embodiments, the present invention receives, from the user, a request to change to a second platform. In some embodiments, the present invention transfers, using the GINT module and the platforms operational layer, the properties from the first platform to the second platform.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for multi-platform interoperability in digital environments, in accordance with an embodiment of the disclosure.

FIG. 2 illustrates a process flow for multi-platform interoperability in digital environments, in accordance with an embodiment of the disclosure.

FIG. 3 illustrates a process flow for transferring properties from a first platform to a second platform, in accordance with an embodiment of the disclosure.

FIG. 4 illustrates a non-limiting example process flow of the multi-platform interoperability system, in accordance with an embodiment of the disclosure.

FIG. 5 illustrates an additional non-limiting example process flow of the multi-platform interoperability system, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “digital environment” may include an integrated communications environment where digital devices communicate and manage the content and activities within it. For instance, a digital environment may include websites, servers, search engines, social media applications, mobile applications, audio resources, video resources, web-based resources, extended reality systems, augmented reality systems, virtual reality systems, and/or the like. Furthermore, “digital environment” may include any resource that may be either a computer-based resource, mobile device-based resource, electronically-based resource, and/or the like. Furthermore, organizations, individuals, entities, businesses, and/or the like may adopt, integrate, associate, or otherwise include digital environments in their interactions. For example, a digital environment may include email servers, storage servers, application-specific programs, web-based applications, and/or the like.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “transfer,” a “distribution,” and/or an “allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

Currently, existing digital environment platforms are developed using different standards, technologies, programming languages, and/or the like, and may not have the same level of user experience. The lack of integration of the platforms to operate with one another creates issues and leads to reductions in performance. For example, challenges of interoperability exists between digital platforms such as: inability to design and use the same avatars, features, and objects (e.g., lack of feature interoperability); increased development time and re-creation of objects in differing programming languages; inability to display unique user objects on all platforms (e.g., lack of object interoperability); absence of cross platform operability regarding device and property sharing (e.g., lack of language support); a need to share user information, device information, and other personal information every time there is an interaction to differing platforms (e.g., lack of central operational layers and dashboards). Therefore, due to the reduction in user experience and productivity on all virtual platforms, a need exists for multi-platform interoperability.

The present invention may include one or more different platforms wherein each platform may be associated with their own entity. In some embodiments, the system may receive features from a central features repository dashboard (CFRD). The CFRD may include features from a user, a user device, an entity, an entity device, and/or the like. The CFRD may be available to the user to interact with the system in a seamless way and may act as a single entry point for features within the CFRD. In some embodiments, the features may be platform independent (e.g., features owned by the user and not the platform). In some embodiments, the features may flow between platforms in response to the generator, integrator, tailor (GINT) module. In some embodiments, the feature tailor (e.g., from the GINT module) may transfer properties of a feature between the platforms. In some embodiments, the feature integrator (e.g., from the GINT module) may transfer objects between the platforms. In some embodiments, the feature generator (e.g., from the GINT module) may transfer functions between the platforms. In this way, a user may create a feature in the CFRD, which will be transferred to the system via the CFRD, and the feature may be transferred between the virtual platforms using the GINT module.

What is more, the present disclosure provides a technical solution to a technical problem. As described herein, the technical problem includes differing standards, technologies, programming languages, and/or the like with regard to digital environments. The technical solution presented herein allows for enabling cross platform interoperability using components that collate unique objects, user information, entity information, and/or the like using a central features repository dashboard. In particular, the multi-platform interoperability system is an improvement over existing solutions to the lack of interoperability in existing digital environments, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the technical solution described herein is an improvement to computer technology and is directed to non-abstract improvements to the functionality of a computer itself. Specifically, the multi-platform interoperability system as described herein is a solution to the problem of existing digital environments developed using differing standards, technologies, programming languages, and/or the like producing varying levels of user experiences across the differing environments. Further, the multi-platform interoperability system may be characterized as identifying a specific improvement in computer capabilities and/or network functionalities in response to the multi-platform interoperability system's integration to existing devices, software, applications, digital environments, environments, virtual reality environments, augmented reality environments, extended reality environments, and/or the like. In this way, the multi-platform interoperability system improves the capability of a system to perform multi-platform interoperability in digital environments. Further, the multi-platform interoperability system improves the functionality of networks in response to reducing the resources consumed by the system (e.g., network resources, computing resources, memory resources, and/or the like).

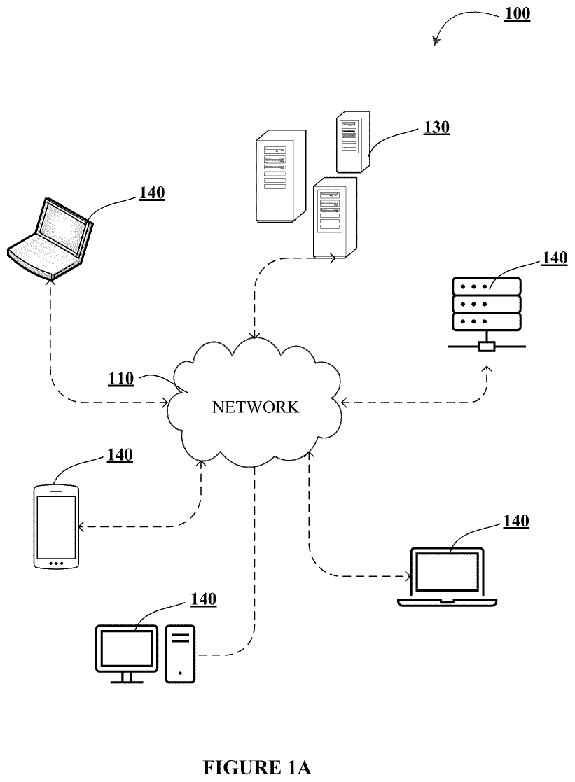

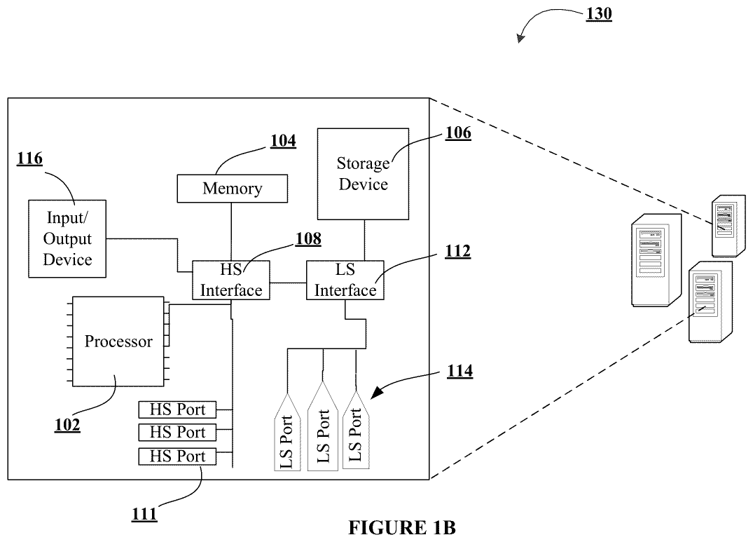

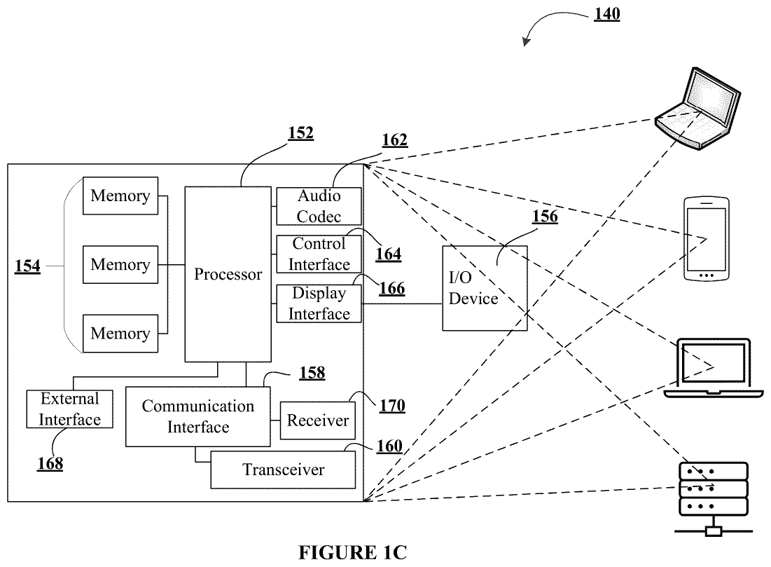

FIGS. 1A-1C illustrate technical components of an exemplary distributed computing environment 100 for multi-platform interoperability in digital environments, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server (e.g., system 130). In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, resource distribution devices, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion, or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer (e.g., laptop computer, desktop computer, tablet computer, mobile telephone, and/or the like). Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed application specific integrated circuits (ASICs), computer hardware, firmware, software, and/or combinations thereof.

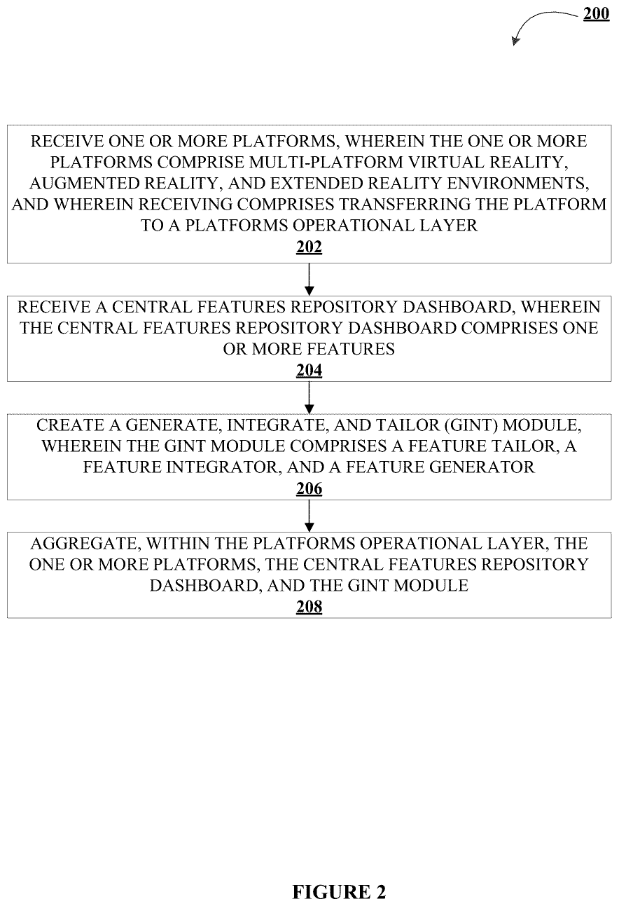

FIG. 2 illustrates a process flow for multi-platform interoperability in digital environments, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a multi-platform interoperability system (e.g., similar to one or more of the systems described herein with respect to FIGS. 1A-1C) may perform one or more of the steps of process flow 200. For example, a multi-platform interoperability system (e.g., the system 130 described herein with respect to FIGS. 1A-1C) may perform the steps of process flow 200.

As shown in block 202, the process flow 200 of this embodiment includes receiving one or more platforms, wherein the one or more platforms comprise multi-platform virtual reality, augmented reality, and extended reality environments, and wherein receiving comprises transferring the platform to a platforms operational layer. In some embodiments, the one or more platforms includes platform plugins, libraries, packages, and/or the like. In some embodiments, the platforms may include different language-based platforms, which may include different computer coding languages. In some embodiments, the platforms may support different languages (e.g., coding languages, programming languages, and/or the like). In some embodiments, the platforms may include virtual platforms, which may host user avatars, objects, institutions, and/or the like. In some embodiments, the virtual platforms (e.g., platforms) may be handled in the operational layer with the GINT module.

In some embodiments, the virtual environments (e.g., one or more platforms) may include virtual reality, augmented reality, parallel reality, extended reality, and/or the like. In some embodiments, the virtual environments may allow the user to interact with them in a virtual way. In some embodiments, the user may interact with the virtual environments on a user device. In some embodiments, the user device may include a headset, a mobile phone, a computer tablet, a personal computer, a smart device, and/or the like.

In some embodiments, the platforms operational layer may include multi and cross platform integration. In some embodiments, the platforms operational layer may implement support for the features collated in the central features repository dashboard (CFRD). In this way, the CFRD may be dynamically assigned, mapped, and native support may be implemented.

As shown in block 204, the process flow 200 of this embodiment includes receiving a central features repository dashboard, wherein the central features repository dashboard comprises one or more features. In some embodiments, the central features repository dashboard (CFRD) may be a repository of all features. In some embodiments, the CFRD may store the features from the virtual platform(s), the user (e.g., information relating to a user and/or user device), the entity (e.g., information relating to an entity and/or entity device), and/or the like. In some embodiments, the CFRD will allow the user, entity, virtual platform(s), and/or the like to view the features available in a particular session in the multi-platform interoperability system.

In some embodiments, the CFRD may act as a single-entry point to the platforms operational layer. In this way, the multi-platform interoperability system may accept features through the CFRD. In some embodiments, the CFRD may transfer features to the virtual platforms within the platform operational layer. In this way, the CFRD may distribute features to their appropriate location throughout the platform operational layer. In some embodiments, the CFRD may transmit the user feature, entity feature, virtual platform feature to the platforms operational layer.

In some embodiments, the CFRD may include receiving, from a user device, a user feature, wherein the user feature comprises features specific to a user. In some embodiments, the user feature may include information relating to a user, information relating to a user device, and/or the like. In this way, the user feature may be received from the user, wherein the multi-platform interoperability system receives the user feature from the user device.

For instance, and by way of non-limiting example, if a user designs an avatar, the user may transfer the avatar to the CFRD. Further, in some embodiments, the multi-platform interoperability system may take the avatar from the CFRD and place it in the different virtual platforms the user interacts with. In this way, the user may not have to design (e.g., re-design) multiple avatars that are specific to each of the virtual platforms, but may be able to design a single avatar that is able to be replicated across all of the virtual platforms.

Additionally, or alternatively, the CFRD may allow the user to control the user created features. In this way, the user's user features may be created in a platform-independent way, which allows the features to operate with multiple types of virtual platforms. In some embodiments, the CFRD may allow the user to own the user features (e.g., user features and associated data) rather than giving control of the user features to a virtual platform and/or entity.

In some embodiments, the central features repository dashboard includes receiving, from an entity device, an entity feature, wherein the entity features comprises features specific to an entity. For instance, and by way of non-limiting example, an entity feature may include a payment function, wherein the payment function allows the user to purchase an item in the virtual platform the user is interacting with. In this way, the payment function (e.g., entity feature) may be stored in the CFRD. Further, in some embodiments, the payment function may be used throughout the various virtual platforms the user interacts with. In this way, the entity may create, control, store, operate, and/or the like the payment function rather than the virtual platform doing so.

In some embodiments, storing features in the CFRD may allow for a reduction in consumption of resources (e.g., computing resources, networking resources, storage resources, and/or the like) in response to the use (e.g., re-use) of the features in the CFRD. For instance, and by way of non-limiting example, the features in the CFRD may not need to be replicated among the one or more virtual platforms, saving development resources, operational resources, and/or the like associated with the design and operation of each of the features.

Additionally, or alternatively, the CFRD may allow an entity to control which features need to be created for the user to interact with the virtual environment. In this way, the entity may develop certain features which enhance user experience without waiting on the virtual platform owner to develop those certain features. For instance, and by way of non-limiting example, an entity may discover that a user is missing a key feature that allows the user to fully interact with a virtual environment (e.g., a payment function for a certain item in the virtual environment). In this way, the entity may develop a feature that allows the user to pay for the certain item without waiting for the virtual platform (e.g., developers associated with the virtual platform) to create the feature. Additionally, or alternatively, the entity developing the feature may allow the entity to create a platform independent feature that allows the feature to operate within multiple types of virtual platforms.

In some embodiments, the one or more features may include properties, information, objects, devices, functionalities, lines of code, and/or the like. In some embodiments, the features may include avatars, non-fungible tokens (NFTs), display devices, properties, identifications, unique objects, resource containers, and/or the like.

As shown in block 206, the process flow 200 of this embodiment includes creating a generate, integrate, and tailor (GINT) module, wherein the GINT module comprises a feature tailor, a feature integrator, and a feature generator. In some embodiments, the GINT module includes the feature tailor, wherein the feature tailor assigns properties to the features in the platform operational layer based on the central features repository dashboard. In some embodiments, the feature tailor includes iterating an object property associated with the feature. In some embodiments, the feature tailor includes assigning a parameter based on the central features repository dashboard. In some embodiments, the feature tailor includes performing an object level interoperability.

In some embodiments, the feature tailor may handle features associated with a user, a user device, and/or the like. In some embodiments, the feature tailor may receive features (e.g., features and associated properties) from the CFRD. In some embodiments, the feature tailor may capture which data about the feature is relevant to the feature in a specific interaction (e.g., user interaction in the virtual platform). In this way, the feature tailor may allow for only the relevant feature properties to be displayed in the virtual platforms. For instance, and by way of non-limiting example, if a user customizes the user's avatar, the feature tailor may store the customized user avatar and display the customized user avatar throughout all of the virtual platforms the user interacts with. In this way, the feature tailor may take the properties associated with the customized user avatar and display the customized user avatar across the multiple virtual platforms.

In some embodiments, the GINT module includes the feature integrator, wherein the feature integrator maps functions to the features in the platforms operational layer based on the central features repository dashboard. In some embodiments, the feature integrator includes mapping a platform request based on the central feature repository dashboard. In some embodiments, the feature integrator includes mapping an object request based on the central feature repository dashboard. In some embodiments, the feature integrator includes performing a feature level interoperability.

In some embodiments, the feature integrator may handle features that are associated with an entity, and entity device, and/or the like. In some embodiments, the feature tailor may use user details and entity details to determine which feature in the CFRD should be used to complete the user interaction in the virtual environment. In this way, the feature tailor may handle features associated with an entity, but may also use details associated with both the user and entity to complete the user's request. For instance, and by way of non-limiting example, a user may wish to pay for an item in a virtual environment. Additionally, or alternatively, the payment feature may be associated with an entity (e.g., wherein the entity created the payment feature). In this way, the feature tailor may collect user details (e.g., user details relating to a user payment of the item) when completing the payment function feature.

In some embodiments, the feature tailor may limit the user of certain features to only a particular virtual platform. In some embodiments, the condition to limit the use of the features may be due to the transmission of sensitive information. For instance, and by way of non-limiting example, if a user wishes to pay for an item in a virtual platform, the payment feature may only be available in that particular virtual platform until the payment is completed. In this way, the multi-platform interoperability system may limit the access to the payment feature in response to the user's payment information being transmitted.

In some embodiments, the GINT module includes the feature generator, wherein the feature generator generates functions in the features in the platforms operational layer based on the central features repository dashboard. In some embodiments, the feature generator includes generating, in response to the central features repository dashboard, a native platform characteristic, wherein the native platform characteristic comprises the one or more platform plugins, libraries, and packages. In some embodiments, the feature generator includes performing a platform level interoperability.

In some embodiments, the feature generator may allow an entity to control certain features within the multi-platform interoperability system. In some embodiments, the entity may be a financial institution that is associated with a user account (e.g., the user's financial account). In some embodiments, the feature generator may allow the financial institution (e.g., entity) to request payment directly from the user for a user interaction within a virtual platform. For instance, and by way of non-limiting example, a user may interact with a virtual platform in a way that the user decides to purchase an item within the virtual platform's store. In this way, the feature generator may allow the financial institution (e.g., entity) to request payment directly from the user rather than requesting through the virtual platform. In some embodiments, the feature generator may conserve resources conventional systems consume by bypassing the virtual platform's payment request from the user. Further, in some embodiments, the financial institution may now securely accept, store, and complete the user's payment for the item in the virtual platform.

Additionally, or alternatively, the entity may create functionalities associated with a feature that may be transferred to each virtual platform through the feature generator. In this way, the entity may design, develop, operate, and/or the like certain functionalities associated with a feature in the CFRD. Further, in some embodiments, the entity may make those functionalities available across multiple platforms via multi-platform interoperability (e.g., the entity may create the functionalities in a platform independent way). For instance, and by way of non-limiting example, if an entity creates a function within a payment feature (e.g., a swipe function of the payment feature), the entity may create the function in a platform independent way. Additionally, or alternatively, the entity may make the swipe function available in multiple virtual platforms based on the entity developing that function.

As shown in block 208, the process flow 200 of this embodiment includes aggregating, within the platforms operational layer, the one or more platforms, the central features repository dashboard, and the GINT module. In some embodiments, the multi-platform interoperability system receives the feature from the central feature repository dashboard. In some embodiments, the multi-platform interoperability system assigns, using the GINT module, properties to the feature in a first platform. In some embodiments, the multi-platform interoperability system receives, from the user, a request to change to a second platform. In some embodiments, the multi-platform interoperability system transfers, using the GINT module and the platforms operational layer, the features from the first platform to the second platform.

As used herein, a platform may include a virtual platform layer. In some embodiments, the virtual platform layer (e.g., platform) may include a representation of an available multi-platform virtual reality environment, augmented reality environment, extended reality environment, and/or the like which may host user avatars, objects, entities, and/or the like. These virtual platforms may hold multiple languages, plugins, packages, libraries, indexes, support, and/or the like.

As used herein, the central features repository dashboard (CFRD) may include a visual feature display made available using the entity information and the user information. In some embodiments, a combination of available details may be available in the visual feature display (e.g., from databases, user inputs, settings, and/or the like) and may include details such as user avatars, alternate avatars, device properties, other user defined properties, user information, entity information, and/or the like. In some embodiments, the features may include user-defined settings, which may apply to or limit certain features in the digital environment.

In some embodiments, the CFRD may be used to create to securely use unique objects within the virtual environments (e.g., virtual platforms) without actually designing, creating, downloading, and/or the like the unique objects within the virtual platforms.

As used herein, the platforms operational (PLOP) layer may include multi and cross platform integration. In some embodiments, the PLOP layer may collate the features in the central features repository dashboard (CFRD), wherein the features can be dynamically assigned, mapped, and/or the like, and support may be implemented. In some embodiments, the PLOP layer may include the GINT module. In some embodiments, the GINT module may enhance rendering, seamless inter-platform operability, user experience, and/or the like.

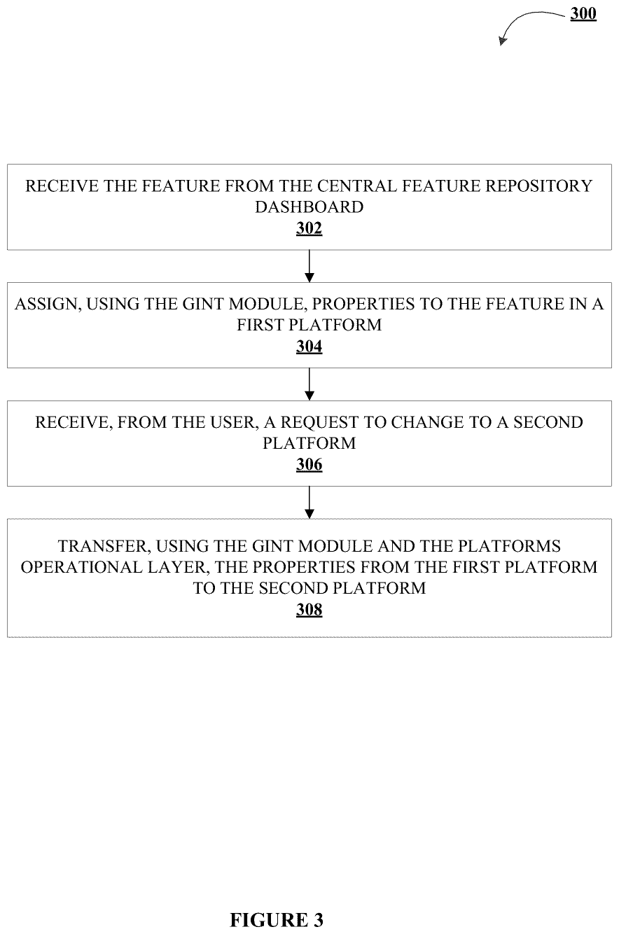

FIG. 3 illustrates a process flow for transferring the properties from the first platform to the second platform, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a multi-platform interoperability system (e.g., similar to one or more of the systems described herein with respect to FIGS. 1A-1C) may perform one or more of the steps of process flow 300. For example, a multi-platform interoperability system (e.g., the system 130 described herein with respect to FIGS. 1A-1C) may perform the steps of process flow 300.

As shown in block 302, the process flow 300 of this embodiment includes receiving the feature from the central feature repository dashboard. In some embodiments, receiving the feature may include receiving information associated with a user, a user device, an entity, an entity device, and/or the like. In some embodiments, the feature may include a particular feature designed by the user, such as a user avatar. In some embodiments, the user may design one or more avatar for different user interactions within the virtual environment (e.g., virtual platform). In some embodiments, the CFRD may store the one or more user avatars until the user selects the appropriate avatar to be displayed in the virtual environment. In some embodiments, only one of the avatars may be used at once while the user is in a session in the virtual environment.

As shown in block 304, the process flow 300 of this embodiment includes assigning, using the GINT module, properties to the feature in a first platform. In some embodiments, the first platform may be a first virtual environment (e.g., virtual platform). In some embodiments, assigning properties may include assigning properties with the feature tailor. In this way, the feature tailor may receive properties from the feature in the CFRD and transfer the properties to the feature in the first virtual platform.

For instance, and by way of non-limiting example, the user may design one of the user avatars to use during formal business meetings. In this way, the CFRD may transfer the features associated with the avatar when the user is interacting in a business meeting in the first platform.

As shown in block 306, the process flow 300 of this embodiment includes receiving, from the user, a request to change to a second platform. In some embodiments, the user may switch to a second virtual environment (e.g., virtual platform). In some embodiments, the user may have access to all of the available virtual platforms from the user device.

As shown in block 308, the process flow 300 of this embodiment includes transferring, using the GINT module and the platforms operational layer, the properties from the first platform to the second platform. In some embodiments, the feature and associated property, such as a display resolution of the feature, may also transfer between the virtual platforms. In this way, the feature tailor may, in response to receiving the feature property from the CFRD, transfer the feature property between the virtual platforms as the user switches the virtual platforms.

For instance, and by way of non-limiting example, if the user has a second business meeting in the second virtual platform, the CFRD and the feature tailor may transfer the features associated with the business avatar to the second platform when the user switches platforms. In this way, the features of the user avatar will follow the user switching the virtual platforms the user is interacting with.

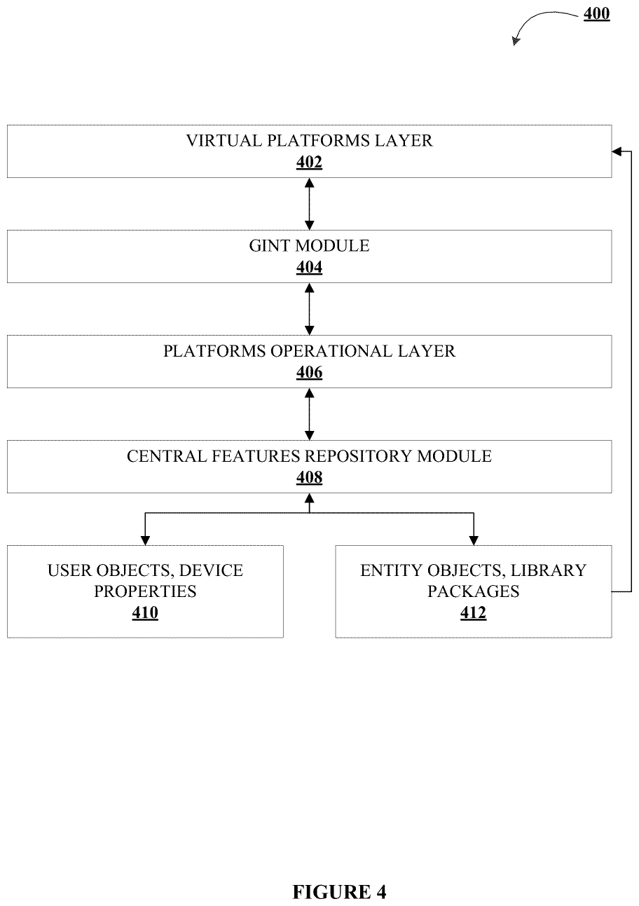

FIG. 4 illustrates a process flow for a non-limiting example process flow of the multi-platform interoperability system, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a multi-platform interoperability system (e.g., similar to one or more of the systems described herein with respect to FIGS. 1A-1C) may perform one or more of the steps of process flow 400. For example, a multi-platform interoperability system (e.g., the system 130 described herein with respect to FIGS. 1A-1C) may perform the steps of process flow 400.

As shown in block 402, the process flow 400 of this embodiment includes a virtual platforms layer. In some embodiments, the virtual platforms layer may include a layer that hosts users avatars, objects, institutions, and/or the like. In some embodiments, the virtual platforms layer may support multiple languages, plugins, libraries, and/or the like. In some embodiments, the virtual platforms layer may be handled in the platforms operational layer. In some embodiments, the virtual platforms may include different coding languages, platform plugins, libraries, packages, and/or the like.

In some embodiments, the virtual platforms layer may transfer features to the GINT module. In some embodiments, the features may be specific to the virtual platform layer. In some embodiments, the features may be in the native language of the virtual platform layer. In some embodiments, the features may include plugins, libraries, packages, and/or the like. In some embodiments, the virtual platform may allow the user to interact with the features of the virtual platform. In some embodiments, the virtual platform may be a virtual reality, augmented reality, extended reality, and/or the like environment that allows the user to interact with a virtual environment. In some embodiments, the user may interact with the virtual platform with the user device. In some embodiments, the user device may include a virtual reality headset, an augmented reality headset, a mobile device, a personal computer, and/or the like.

As shown in block 404, the process flow 400 of this embodiment includes a GINT module. In some embodiments, the GINT module may receive features, objects, functions, and/or the like from the virtual platforms layer. In some embodiments, the GINT module may include the feature tailor, feature integrator, and feature generator.

As shown in block 406, the process flow 400 of this embodiment includes the platforms operational layer. In some embodiments, the platforms operational layer may include the features from the CFRD, virtual platforms, and/or the like. In some embodiments, the features may include features designed, developed, operated, and/or the like by an entity, wherein the entity's feature is stored in the CFRD. In this way, the entity may create (e.g., design, develop, operate, and/or the like) a specific feature that allows for additional user functionality.

As shown in block 408, the process flow 400 of this embodiment includes a central features repository module. In some embodiments, the feature created by the entity may be stored in the CFRD. In some embodiments, the entity may create the feature within the CFRD. In some embodiments, the feature may be created in such a way that allows for multi-platform interoperability (e.g., created to be platform independent). In this way, the CFRD may transfer the feature to the appropriate virtual platform without the need for creation (e.g., re-creation) of a new feature.

As shown in block 410, the process flow 400 of this embodiment includes user objects and device properties. In some embodiments, the entity created feature may interact with user information (e.g., user objects, user device properties, and/or the like). In this way, the entity feature may have functionality that allows interaction from a user while also obtaining information from the user.

As shown in block 412, the process flow 400 of this embodiment includes entity objects and library packages. In some embodiments, the entity objects and library packages may include functionalities associated with the entity created feature.

For instance, and by way of non-limiting example, if an entity creates (e.g., designs, develops, operates, and/or the like) a particular feature with certain functionalities in the multi-platform interoperability system, the entity may store the feature in the CFRD. In some embodiments, the feature may be transferred to a virtual platforms layer through the GINT module. In some embodiments, the platforms operational layer and the GINT module may transfer the feature throughout the one or more virtual platforms the user interacts with. In this way, the entity may have control over the functionalities of the feature as the user interacts with the feature.

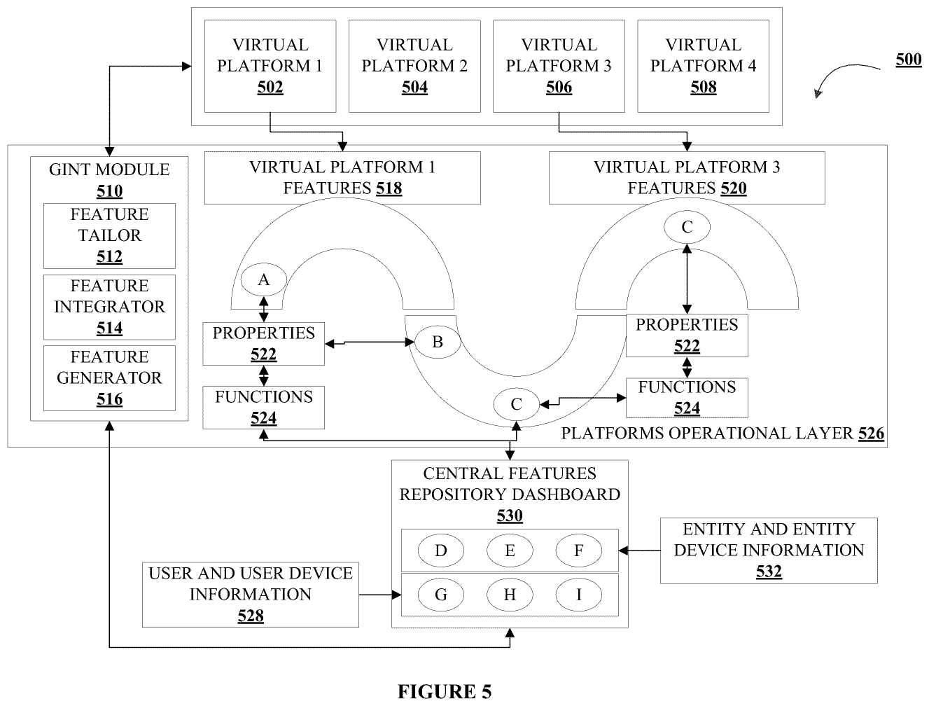

FIG. 5 illustrates a process flow for an additional non-limiting example process flow of the multi-platform interoperability system, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device with computer-readable program code stored thereon and accessible by the at least one processing device, wherein the computer-readable code when executed is configured to carry out the method discussed herein.

In some embodiments, a multi-platform interoperability system (e.g., similar to one or more of the systems described herein with respect to FIGS. 1A-1C) may perform one or more of the steps of process flow 500. For example, a multi-platform interoperability system (e.g., the system 130 described herein with respect to FIGS. 1A-1C) may perform the steps of process flow 500.

As shown in block 502, the process flow 500 of this embodiment includes a virtual platform 1. In some embodiments, the virtual platform may be hosted, controlled, designed, developed, operated, and/or the like by a third party entity that specializes in the creation of virtual environments. In some embodiments, the virtual platform may include its own coding language, functionalities, features, libraries, indexes, objects, and/or the like.

As shown in block 504, the process flow 500 of this embodiment includes a virtual platform 2. In some embodiments, the virtual platform may be hosted, controlled, designed, developed, operated, and/or the like by a third party entity that specializes in the creation of virtual environments. In some embodiments, the virtual platform may include its own coding language, functionalities, features, libraries, indexes, objects, and/or the like.

As shown in block 506, the process flow 500 of this embodiment includes a virtual platform 3. In some embodiments, the virtual platform may be hosted, controlled, designed, developed, operated, and/or the like by a third party entity that specializes in the creation of virtual environments. In some embodiments, the virtual platform may include its own coding language, functionalities, features, libraries, indexes, objects, and/or the like.

As shown in block 508, the process flow 500 of this embodiment includes a virtual platform 4. In some embodiments, the virtual platform may be hosted, controlled, designed, developed, operated, and/or the like by a third party entity that specializes in the creation of virtual environments. In some embodiments, the virtual platform may include its own coding language, functionalities, features, libraries, indexes, objects, and/or the like.

As shown in block 510, the process flow 500 of this embodiment includes a GINT module. In some embodiments, the GINT module may be placed in the platforms operational layer (e.g., similar to platforms operational layer 526). In some embodiments, the GINT module may receive features from the one or more virtual platforms (e.g., virtual platform 1 502, virtual platform 2 504, virtual platform 3 506, virtual platform 4 508, and/or the like). In some embodiments, the GINT module may receive features form the CFRD 530. In some embodiments, the GINT module may transfer the received features (e.g., from the CFRD 530, virtual platforms, and/or the like) to the other virtual platforms.

As shown in block 512, the process flow 500 of this embodiment includes a feature tailor. In some embodiments, the feature tailor may receive properties of features from the GINT module. In this way, the feature tailor may receive properties of features from the virtual platforms (e.g., 502, 504, 506, or 508) or the CFRD 530. In some embodiments, the feature tailor may receive user features 528 from the CFRD 530. In some embodiments, the feature tailor may transfer the features (e.g., and associated properties) throughout the virtual environments the user interacts with.

As shown in block 514, the process flow 500 of this embodiment includes a feature integrator. In some embodiments, the feature integrator may receive features from the GINT module. In this way, the feature integrator may receive features from the virtual platforms (e.g., 502, 504, 506, or 508) and the CFRD 530. In some embodiments, the feature integrator may receive entity features 532 from the CFRD 530. In some embodiments, the feature integrator may transfer the features throughout the virtual environments the user interacts with.

As shown in block 516, the process flow 500 of this embodiment includes a feature generator. In some embodiments, the feature generator may receive features and the associated functionalities from the virtual platforms and the GINT module. In this way, the feature integrator may receive features and associated functionalities from the virtual platforms (e.g., 502, 504, 506, or 508) and CFRD 530. In some embodiments, the feature generator may transfer the features and associated functionalities throughout the virtual environments the user interacts with.

As shown in block 518, the process flow 500 of this embodiment includes virtual platform 1 features. In some embodiments, the virtual platform 1 features may be features specific to the virtual platform 1. In some embodiments, these features may include features created (e.g., designed, developed, operated, and/or the like) by the entity that hosts virtual platform 1. In some embodiments, the user may interact with the features in the virtual platform 1. In some embodiments, the user may interact with different features while still remaining in virtual platform 1 in response to the multi-platform interoperability system transferring the features into virtual platform 1. For instance, and by way of non-limiting example, if the user is in virtual platform 1, but wishes to use an avatar created elsewhere (e.g., in the CFRD, in virtual platform 2, virtual platform 3, virtual platform 4, and/or the like), then the feature tailor 512 of the GINT module 510 may transfer that user avatar to virtual platform 1. In some embodiments, the user avatar may retain the features the with which user initially created the avatar.

As shown in block 520, the process flow 500 of this embodiment includes virtual platform 3 features. In some embodiments, the virtual platform 3 features may be features specific to the virtual platform 3. In some embodiments, these features may include functionalities created (e.g., designed, developed, operated, and/or the like) by the entity that hosts virtual platform 3. In some embodiments, an entity may create a feature with a functionality that enhances user experience. In some embodiments, this feature and associated functionality may be transferred to virtual platform 3 through the feature integrator 514 of the GINT module 510.

As shown in block 522, the process flow 500 of this embodiment includes properties. In some embodiments, the features may have properties associated with them that may be transferred between the virtual platforms. In some embodiments, the properties 522 may be received from the CFRD 530.

As shown in block 524, the process flow 500 of this embodiment includes functions. In some embodiments, certain features may have functions associated with them that may be transferred between the virtual platforms. In some embodiments, the functions 524 may be received from the virtual platforms, CFRD 530, and/or the like.

As shown in block 526, the process flow 500 of this embodiment includes a platforms operational layer. In some embodiments, the platforms operational layer may include the GINT module 510, the virtual platforms (e.g., 502, 504, 506, or 508), virtual platform features (e.g., virtual platform 1 features 518, virtual platform 3 features, and/or the like), properties 522, functions 524, and/or the like. In some embodiments, the platforms operational layer 526 may allow for the aggregation of the various components of the multi-platform interoperability system. In this way, the user may interact with the virtual platforms within the platforms operational layer 526, which may also allow the user to switch between the virtual platforms while also transferring features (e.g., and associated properties and/or functions) between the virtual platforms.

As shown in block 528, the process flow 500 of this embodiment includes user and user device information. In some embodiments, the user and user device information may include features created by the user, personal information of the user, user device information, and/or the like.

As shown in block 530, the process flow 500 of this embodiment includes a central features repository dashboard (CFRD). The CFRD may assist the user define certain settings relating to the user's features. In some embodiments, the CFRD may help in applying or limiting certain features while the user is interacting with the virtual environment.

As shown in block 532, the process flow 500 of this embodiment includes entity and entity device information. In some embodiments, the entity and entity device information may include features create by the entity, entity information of the entity, entity device information, and/or the like.

For instance, a user may be in a virtual environment (e.g., virtual platform 1 502). The virtual environment may include virtual platform 1 features 518, which may allow the user to purchase virtual items. The user may be virtually shopping for an article of clothing (e.g., feature A in process flow 500) for the user's virtual avatar (e.g., a user feature). The system may have received user information 528 that relates to the user avatar's article of clothing size from the user via the central features repository dashboard 530. The system may transfer the article of clothing size (e.g., user information 528) from the CFRD 530 to the feature properties 522 in the platforms operational layer 526 via the feature tailor 512. In this way, the user will only see the correct article of clothing size (e.g., based on user information 528) when the user is interacting with the virtual environment (e.g., virtual platform 1 502).

If the user decides to purchase and pay for the article of clothing, the user may pay for the article of clothing using a feature created by an entity. In this way, the CFRD 520 may receive an entity feature (e.g., from an entity 532) and transfer it to the platforms operational layer 526 via the feature integrator 514 so the user may interact with the feature. The feature may include a payment functionality that will be associated with the feature A (e.g., stored in the properties 522 of feature A).

In some instances, virtual platform 1 502 may not support a user payment feature of the article of clothing. The user may switch virtual environments (e.g., to virtual platform 2 504) in order to pay for the article of clothing. In this way, the user will change virtual platforms, and the system will transfer the properties and functionalities of the article of clothing using the GINT module 510. Now that the user is in virtual platform 2 504, the user may use a payment feature (e.g., feature B in process flow 500) that allows the user to pay for the article of clothing with the feature and associated functions created by the entity (e.g., from entity 532). In some embodiments, the GINT module 510 may transfer the payment feature (e.g., feature B of process flow 500) from virtual platform 2 504 to virtual platform 1 502 without the user needing to switch between the platforms to pay for the article of clothing.

In some embodiments, the user may choose between one or more resource containers (e.g., feature C in process flow 500) to pay for the article of clothing. In some embodiments, the virtual platforms may treat the resource containers and their associated properties and functions differently than one another. In this way, the virtual platform 2 504 may allow the user to display the resource containers in a virtual wallet the user may interact with. Further, in some embodiments, virtual platform 4 508 may allow the user to virtually swipe the resource container in virtual platform 4 508. In some embodiments, the multi-platform interoperability system may allow the user to perform any and all of the actions (e.g., interactions in the virtual environments) in any of the virtual platforms the user may interact with. In this way, the system may, through the GINT module 510, allow the user to display and swipe the resource container in virtual platform 1 regardless of whether virtual platform 1's native programming allows for the user to do so.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for multi-platform interoperability in digital environments, the system comprising:
a processing device;
a non-transitory storage device containing instructions when executed by the processing device, causes the processing device to perform the steps of:
receive one or more platforms, wherein the one or more platforms comprise multi-platform virtual reality, augmented reality, and extended reality environments, and wherein receiving comprises transferring the platform to a platforms operational layer;
receive a central features repository dashboard, wherein the central features repository dashboard comprises one or more features;
create a generate, integrate, and tailor (GINT) module, wherein the GINT module comprises a feature tailor, a feature integrator, and a feature generator; and
aggregate, within the platforms operational layer, the one or more platforms, the central features repository dashboard, and the GINT module.

2. The system of claim 1, wherein the central features repository dashboard comprises:
receiving, from a user device, a user feature, wherein the user feature comprises features specific to a user;
receiving, from an entity device, an entity feature, wherein the entity features comprises features specific to an entity; and
transmitting the user feature and the entity feature to the platforms operational layer in response to the GINT module.

3. The system of claim 1, wherein the GINT module comprises:
the feature tailor, wherein the feature tailor assigns properties to the features in the platforms operational layer based on the central features repository dashboard;
the feature integrator, wherein the feature integrator maps functions to the features in the platforms operational layer based on the central features repository dashboard; and
the feature generator, wherein the feature generator generates functions in the features in the platforms operational layer based on the central features repository dashboard.

4. The system of claim 3, wherein the feature tailor further comprises:
iterating an object property associated with the feature;
assigning a parameter based on the central features repository dashboard; and
performing an object level interoperability.

5. The system of claim 3, wherein the feature integrator further comprises:
mapping a platform request based on the central feature repository dashboard;
mapping an object request based on the central feature repository dashboard; and
performing a feature level interoperability.

6. The system of claim 3, wherein the feature generator further comprises:
generating, in response to the central features repository dashboard, a native platform characteristic, wherein the native platform characteristic comprises the one or more platform plugins, libraries, and packages; and
performing a platform level interoperability.

7. The system of claim 1, wherein executing the instructions further causes the processing device to:
receive the feature from the central feature repository dashboard;
assign, using the GINT module, properties to the feature in a first platform;
receive, from the user, a request to change to a second platform; and
transfer, using the GINT module and the platforms operational layer, the properties from the first platform to the second platform.

8. A computer program product for multi-platform interoperability in digital environments, the computer program product comprising a non-transitory computer-readable medium comprising code causing an apparatus to:
receive one or more platforms, wherein the one or more platforms comprise multi-platform virtual reality, augmented reality, and extended reality environments, and wherein receiving comprises transferring the platform to a platforms operational layer;
receive a central features repository dashboard, wherein the central features repository dashboard comprises one or more features;
create a generate, integrate, and tailor (GINT) module, wherein the GINT module comprises a feature tailor, a feature integrator, and a feature generator; and
aggregate, within the platforms operational layer, the one or more platforms, the central features repository dashboard, and the GINT module.

9. The computer program product of claim 8, wherein the central features repository dashboard comprises:
receiving, from a user device, a user feature, wherein the user feature comprises features specific to a user;
receiving, from an entity device, an entity feature, wherein the entity features comprises features specific to an entity; and
transmitting the user feature and the entity feature to the platforms operational layer in response to the GINT module.

10. The computer program product of claim 8, wherein the GINT module comprises:
the feature tailor, wherein the feature tailor assigns properties to the features in the platforms operational layer based on the central features repository dashboard;
the feature integrator, wherein the feature integrator maps functions to the features in the platforms operational layer based on the central features repository dashboard; and
the feature generator, wherein the feature generator generates functions in the features in the platforms operational layer based on the central features repository dashboard.

11. The computer program product of claim 10, wherein the feature tailor further comprises:
iterating an object property associated with the feature;
assigning a parameter based on the central features repository dashboard; and
performing an object level interoperability.

12. The computer program product of claim 10, wherein the feature integrator further comprises:
mapping a platform request based on the central feature repository dashboard;
mapping an object request based on the central feature repository dashboard; and
performing a feature level interoperability.

13. The computer program product of claim 10, wherein the feature generator further comprises:
generating, in response to the central features repository dashboard, a native platform characteristic, wherein the native platform characteristic comprises the one or more platform plugins, libraries, and packages; and
performing a platform level interoperability.

14. The computer program product of claim 8, wherein the code further causes the apparatus to:
receive the feature from the central feature repository dashboard;
assign, using the GINT module, properties to the feature in a first platform;
receive, from the user, a request to change to a second platform; and
transfer, using the GINT module and the platforms operational layer, the properties from the first platform to the second platform.

15. A method for multi-platform interoperability in digital environments, the method comprising:
receiving one or more platforms, wherein the one or more platforms comprise multi-platform virtual reality, augmented reality, and extended reality environments, and wherein receiving comprises transferring the platform to a platforms operational layer;
receiving a central features repository dashboard, wherein the central features repository dashboard comprises one or more features;
creating a generate, integrate, and tailor (GINT) module, wherein the GINT module comprises a feature tailor, a feature integrator, and a feature generator; and
aggregating, within the platforms operational layer, the one or more platforms, the central features repository dashboard, and the GINT module.

16. The method of claim 15, wherein the central features repository dashboard comprises:
receiving, from a user device, a user feature, wherein the user feature comprises features specific to a user;
receiving, from an entity device, an entity feature, wherein the entity features comprises features specific to an entity; and
transmitting the user feature and the entity feature to the platforms operational layer in response to the GINT module.

17. The method of claim 15, wherein the GINT module comprises:
the feature tailor, wherein the feature tailor assigns properties to the features in the platforms operational layer based on the central features repository dashboard;
the feature integrator, wherein the feature integrator maps functions to the features in the platforms operational layer based on the central features repository dashboard; and
the feature generator, wherein the feature generator generates functions in the features in the platforms operational layer based on the central features repository dashboard.

18. The method of claim 17, wherein the feature tailor further comprises:
iterating an object property associated with the feature;
assigning a parameter based on the central features repository dashboard; and
performing an object level interoperability.

19. The method of claim 17, wherein the feature integrator further comprises:
mapping a platform request based on the central feature repository dashboard;
mapping an object request based on the central feature repository dashboard; and
performing a feature level interoperability.

20. The method of claim 17, wherein the feature generator further comprises:
generating, in response to the central features repository dashboard, a native platform characteristic, wherein the native platform characteristic comprises the one or more platform plugins, libraries, and packages; and
performing a platform level interoperability.
